(19) United States
(12) Patent Application Publication
(10) Pub. No.: US 2005/0243834 A1
(43) Pub. Date: Nov. 3, 2005

(54) Packet transfer method and device

(76) Inventor: Kenji Fukuda, Yokohama (JP)

Correspondence Address: KATTEN MUCHIN ROSENMAN LLP, 575 MADISON AVENUE, NEW YORK, NY, 10022-2585, US

(21) Appl. No.: 11/152,877

(22) Filed: Jun. 15, 2005

Related U.S. Application Data
(63) Continuation of application No. PCT/JP03/07341, filed on Jun. 10, 2003.

(51) Int. Cl. H04L 12/28

(52) U.S. Cl. 370/395.1

(57) ABSTRACT

In a packet transfer method and device which can reduce a transfer delay and transfer a packet with a small-scale hardware when the packet to which fragmentation is performed after encapsulation is received, a head packet and a subsequent packet are detected from received packets to which the fragmentation is performed after the encapsulation, an inner header of the head packet detected is stored and then decapsulated, the inner header is changed in conformity with the decapsulation, the subsequent packet is further decapsulated, and the inner header of the head packet changed as mentioned above and a fragment offset value in conformity with the fragmentation are assigned to each packet to be outputted.

### BACKGROUND OF THE INVENTION

1. Field of the Invention

The present invention relates to a packet transfer method and device, and in particular to a packet transfer method of receiving and transferring a packet to which fragmentation is performed after encapsulation in an IPv6 or IPv4 network, and a packet transfer device such as a node and a router realizing the method.

2. Description of the Related Art

FIG. 10 shows a generally known IPv6 network, and this example shows an arrangement in which a packet transmitted from a node 10 is transferred to a node 30 through a node 20.

In this case, an IP tunnel TN using an encapsulated IP packet (IP-in-IP packet) is provided between the nodes 10 and 20. The node 10 generates a packet PKT2 that is a packet (composed of an inner header and data) PKT1 encapsulated by an outer header in order to pass through the IP tunnel TN, and transmits the packet to the node 20.

It is to be noted that the “inner header” indicates a header before encapsulation and the “outer header” indicates a header further added after the encapsulation.

The node 20 restores the packet PKT1 from which the outer header is decapsulated to be transferred to the node 30.

When the packet transmitted from the node 10 is fragmented since the packet exceeds a predetermined length, it is required for the node 20 to defragment (reassemble) the fragmented packets before decapsulation (processing for removing the outer header of the IP-in-IP).

FIGS. 11A-11I show a packet transfer method between nodes in the IPv6 network shown in FIG. 10. Hereinafter, packet processing in each of the nodes, specifically in nodes 10 and 20 will be described by referring to FIGS. 11A-11I.

Firstly in node 10, as shown in FIG. 11A, an original packet is composed of an IPv6 header and a datagram (A). In this case, it is supposed that a packet length exceeds 1500 bytes or a path MTU (Maximum Transfer Unit) length.

Thus, the packet length of the original packet exceeds the prescribed 1500 bytes or the path MTU length, so that fragmentation 1 is executed as shown in FIG. 11B. The datagram (A) is divided into two datagrams (A1) and (A2) in this example, the IP header is assigned or added to each of the datagrams, and a fragment header Frg is generated and is inserted between the IPv6 header and each of the datagrams (A1) and (A2).

Then, as shown in FIG. 11C, encapsulation of giving the IPv6 header to each of the divided packets as an outer header and making the IPv6 header shown in FIG. 11B the inner IPv6 header is performed to generate the IP-in-IP packet.

Even when the fragmentation is performed as mentioned above, if the encapsulation is further performed, the packet may exceed the path MTU. In this example, the head packet exceeds the path MTU, where fragmentation 2 is further required as shown in FIG. 11D.

Namely, it is required to further fragment the head packet into two packets as shown in FIG. 11D, and to make the length of the head packet less than the path MTU.

In this case, the datagram (A1) is divided into two datagrams (A1-1) and (A1-2), and an outer IPv6 header with its outer fragment header Out-Frg is prepared for each of the datagrams to be inserted. It is to be noted that the fragment header Frg in the fragmentation 1 shown in FIG. 11B becomes an inner fragment header In-Frg.

Thus, three packets are generated through the fragmentation 1, the encapsulation and the fragmentation 2 in the node 10, and are transmitted to the node 20 as shown in FIG. 11E. It is to be noted that a packet arrival order to the node 20 in this case is not fixed.

In the node 20, as shown in FIG. 11F, a defragmentation (preprocessing) is firstly performed to the head packet and the second packet. This defragmentation is for assembling a packet in conformity with the outer fragment header Out-Frg, in which the outer fragment header Out-Frg is removed from the head packet and the second packet as shown in FIG. 11F, and the outer IPv6 header is removed from the second packet.

As shown in FIG. 11G, the defragmentation is completed, so that the datagrams (A1-1) and (A1-2) to which the preprocessing was performed by the defragmentation as shown in FIG. 11F are combined into the datagram (A1).

Then, the decapsulation is executed as shown in FIG. 11H, the outer IPv6 header of the packet combined in FIG. 11G is removed, and the outer IPv6 header in the third packet is also removed.

Thus, two packets defragmented and decapsulated are transmitted to the node 30 (see FIG. 10) from the node 20 as shown in FIG. 11I.

Also, together with the removal of the outer IPv6 header, the inner IPv6 header becomes the IPv6 header, and the inner fragment header In-Frg becomes the fragment header Frg shown in the fragmentation 1 in FIG. 11B.

In the prior art example shown in FIGS. 11A-11I, the encapsulation is performed after the fragmentation, and the fragmentation is performed again since the necessity of the re-fragmentation occurs (pattern I). In case of the prior art example shown in FIGS. 12A-12H, the encapsulation is firstly performed in the node 10 and then the fragmentation is performed (pattern II).

Firstly, it is supposed that the original packet shown in FIG. 12A is the same as that shown in FIG. 11A.

Then, as shown in FIG. 12B, the encapsulation is performed, and the outer IPv6 header is assigned to the packet to be made the IP-in-IP packet. It is to be noted that together with this encapsulation, the IPv6 header of the original packet becomes the inner IPv6 header.

Supposing that the length of the packet encapsulated exceeds 1500 bytes or the path MTU length in the above-mentioned case, it is required to fragment the packet into three packets in case of the example shown in FIG. 12C.

Therefore, the datagram (A) is divided into datagrams (A1)-(A3), the outer IPv6 header is assigned to each of them, its fragment header Frg is generated to be inserted between the outer IPv6 header and the inner IPv6 header.

Thus, three fragment packets are generated to be outputted from the node 10 as shown in FIG. 12D and transmitted to the node 20. It is to be noted that the packet arrival order to the node 20 in this case is not fixed.

In the node 20, the defragmentation (preprocessing) is executed as shown in FIG. 12E, and the packet is assembled in conformity with the fragment header Frg in each packet. In this case, only the fragment header Frg is removed from the head packet, and all of the headers including the outer IPv6 header and the fragment header Frg are removed from the second packet and the subsequent packet.

As shown in FIG. 12F, the defragmentation is completed, and the datagrams (A1)-(A3) to which the preprocessing was performed in the defragmentation as shown in FIG. 12E are combined into the datagram As shown in FIG. 12G, the decapsulation is performed, the outer IPv6 header is removed, and then the packet is transmitted from the node 20.

As a result, as shown in FIG. 12H, the packet composed of the IPv6 header and the datagram (A) is transmitted from the node 20 to the node 30. Also, the inner IPv6 header shown in FIG. 12G becomes the IPv6 header as shown in FIG. 12H.

Thus, in the conventional technology, in order to decapsulate or get out of IP tunnel in a node the packet to which the processing of encapsulation→fragmentation has been performed in another node, it has been necessary to perform the processing in the procedure of defragmentation→decapsulation, so that defragmentation processing of assembling the packet referring to information (fragment offset value) of the fragment header of the packet has been essential.

The biggest problem at the time of performing such defragmentation processing with hardware is a transfer delay time which occurs at the time of assembling the packet. Since the reversal of a packet order occurs in the IP network, it is indispensable to temporarily buffer the subsequent packet having arrived first and to have it wait until the head packet arrives at the time of assembling the packet, so that a retention time by the buffering becomes the delay time as it is.

Furthermore, in the network device performing wire-speed processing, the packet temporarily buffered is equal to the packet generated within the device. Therefore, when the packet is transmitted while receiving traffic is high, congestion occurs and a queuing time is required, which leads to a further addition of the delay time.

As for another problem, a hardware scale is increased to a large scale due to such buffering. If the buffering is performed to the packet by an individual buffer method, an enormous buffer (memory) is required. If a common buffer method is applied, its hardware arrangement becomes complicated. Also, in order to accommodate to a packet discard (where a part of fragments are discarded or other cases) due to network congestion, a preparation of an assembling timer is required.

On the other hand, there is a relay method for router and a router device with which a packet can be relayed at a high speed without performing fragment processing that causes a delay in relaying at an IP router by transmitting packets that can be settled within a minimum MTU on a path from a host at the source to a host at the destination while the transmission side host grasps that MTU (see e.g. patent document 1).

Also, a model and a general mechanism of an IPv6 encapsulation of an IP packet such as IPv6 and IPv4 are described (see e.g. non-patent document 1)

<Patent Document 1>

Japanese Patent Application Laid-open No. 11-168492 (Page 3 [0029] and FIG. 1)

<Non-Patent Document 1>

“Generic Packet Tunneling in IPv6 Specification”

A. Conta, Lucent Technologies Inc.(Inc.); S. Deering, Cisco Systems (Network Working Group Request for Comments: 2473 Category: Standards Track), December 1998 (Internet URL: http://www.ietf.org/rfc/rfc2460.txt?number=2460)

### SUMMARY OF THE INVENTION

It is accordingly an object of the present invention to provide a method and device which can reduce a transfer delay and can transfer a packet with small-scale hardware when the packet to which fragmentation is performed after encapsulation is received.

In order to achieve the above-mentioned object, a packet transfer method according to the present invention comprises: a first step of detecting a head packet and a subsequent packet from received packets to which fragmentation is performed after encapsulation; a second step of storing an inner header of the head packet detected by the first step and then decapsulating the head packet and changing the inner header in conformity with the decapsulation; and a third step of decapsulating the subsequent packet and of having the inner header of the head packet changed by the second step and a fragment header generated corresponding to the fragmentation assigned to each packet to be outputted.

Namely, in the present invention, the first step detects a head packet and a packet following the head packet (subsequent packet) from received packets to which fragmentation is performed after encapsulation.

The second step stores an inner header of the head packet detected by the first step, then decapsulates the head packet to remove an outer header and its fragment header. Furthermore, the second step modifies the inner header of the head packet stored in conformity with the decapsulation.

The third step firstly decapsulates the subsequent packet detected by the first step, removes its outer header and fragment header, and has the inner header of the head packet modified in conformity with the decapsulation at the above-mentioned second step assigned to the subsequent packet.

At this time, a fragment offset value generated corresponding to each of the packets (head packet and subsequent packet) is also assigned to each of the packets, so that the thus generated packet is outputted.

As mentioned above, in the present invention, the decapsulation is performed with defragmentation processing being skipped, thereby enabling the defragmentation to be performed at a node which will finally receive the packet. Namely, since the decapsulation is enabled by operating the header with a datagram portion of the fragmented packet being unchanged, it becomes possible to eliminate a transfer delay at the time of assembling packets associated with the defragmentation and an increase of a hardware scale.

The above-mentioned first step may include a step of preliminarily registering a fragment identification value in a table regardless of whether or not the received packet is the head packet, and of determining the packet as having been firstly received in absence of a registration of the fragment identification value.

Namely, if a fragment identification value is not registered in a table, it is determined that the packet has been firstly received. In the presence of a registered fragment identification value in the table, it is determined that the packet has been received after the packet firstly received. However in this case, the packet received first is not always the head packet, but may be a subsequent packet.

The above-mentioned fragment identification value may be composed of a source address and a fragment ID in an outer header of the head packet.

Also, the above-mentioned first step may include a step of determining whether or not the received packet is the head packet based on whether or not a fragment offset value in an outer fragment header of the head packet is a predetermined value.

Namely, as for a fragment offset value of the head packet, a predetermined value is generally “0”, so that it becomes possible to determine whether or not the received packet is the head packet based on this value.

Also, the above-mentioned first step may include a step of storing the subsequent packet in a buffer to keep it waiting when determining that the subsequent packet is received before the head packet; the packet transfer method may further comprise a fourth step after the second step of reading the subsequent packet from the buffer to execute the third step.

Namely, as mentioned above, the head packet does not always arrive before the subsequent packet. When it is determined that the subsequent packet was received before the head packet, the subsequent packet is temporarily stored in a buffer to be kept waiting. The fourth step reads the subsequent packet from the buffer after the above-mentioned second step to execute the above-mentioned third step.

Furthermore, the above-mentioned first step may include a step of determining whether a pattern falls into a pattern I or a pattern II based on whether or not the head packet includes the fragment header indicating that the fragmentation is performed before the encapsulation; the packet transfer method may further comprise a fifth step of executing the second step when the pattern is determined to be the pattern I and of executing the second step after generating the fragment header for the head packet when the pattern is determined to be the pattern II, and the third step may include a step of making a fragment offset value in the fragment header a value obtained by subtracting a header length for the subsequent packet from a value before the decapsulation according to a type of the pattern.

Namely, in the pattern I, the encapsulation is performed to the head packet after the fragmentation, and the fragmentation is further performed. In the pattern I, the fragmentation is performed after the encapsulation.

Accordingly, the fifth step executes the above-mentioned second step when the pattern is determined to be the pattern I, and generates a fragment offset value for the head packet before executing the second step when the pattern is determined to be the pattern II. Accordingly, the fragment offset value at the third step may be a value obtained by subtracting a header length for the subsequent packet from a value before the decapsulation according to a type of the above-mentioned pattern.

Also when storing the inner header, the second step may also store a fragment offset value of the head packet in case of the pattern I, may store a fragment offset value generated in case of the pattern II, and the third step may assign the fragment offset value in conformity with the fragmentation to the subsequent packet in either pattern.

Namely, when the second step stores the inner header, it is required to also store or generate a fragment offset value in any form. In case of the pattern I, the fragment offset value of the head packet is also stored at the same time, and in case of the pattern II, the fragment offset value for the head packet is generated to be stored.

At the third step, in case of either pattern, the fragment offset value in conformity with the above-mentioned fragmentation may be assigned to the subsequent packet based on the stored fragment offset value.

Furthermore, the above-mentioned third step may include a step of changing the fragment offset value of the head packet to a value obtained by subtracting data lengths of the inner header and its fragment header from a fragment offset value in its outer fragment header to be assigned to the subsequent packet when the pattern is the pattern I, and of changing the fragment offset value of the head packet to a value obtained by subtracting the data length of the inner header from the fragment offset value in the outer fragment header to be assigned to the subsequent packet when the pattern is the pattern I.

Namely, this indicates a condition for associating the fragment offset value with each packet fragmented. Since the inner fragment header remains in the head packet as it is in case of the pattern I, the fragment offset value of the subsequent packet is changed based on the inner fragment header to a value obtained by subtracting data lengths of the inner header and its fragment header from the fragment offset value. In case of the pattern U, the head packet newly generates, as mentioned above, a fragment offset value, and changes the fragment offset value newly generated to a value obtained by subtracting the data length of the inner header from the fragment offset value to be assigned to the subsequent packet.

Furthermore, the inner header changed by the above-mentioned third step may be a value obtained by subtracting the data lengths of the outer fragment header and the inner header from a payload length in an outer header in case of the pattern I, and the inner header may be a value obtained by subtracting the data length of the inner header from the payload length in the outer header in case of the pattern II.

Namely, a state where the third step changes the inner header is indicated. In case of the above-mentioned pattern I, the value is obtained by subtracting the data lengths of the outer fragment header and the inner header from the payload length within the outer header. In case of the pattern II, it becomes possible to obtain the value by subtracting the data length of the inner header from the payload length within the outer header.

The above-mentioned received packet may comprise an IPv6 packet through an IP tunnel.

A device for realizing the packet transfer method according to the above-mentioned present invention comprises: first means detecting a head packet and a subsequent packet from received packets to which fragmentation is performed after encapsulation; second means storing an inner header of the head packet detected by the first means and then decapsulating the head packet and changing the inner header in conformity with the decapsulation; and third means decapsulating the subsequent packet and having the inner header of the head packet changed by the second means and a fragment header corresponding to the fragmentation assigned to each packet to be outputted.

The above-mentioned first means may include means preliminarily registering a fragment identification value in a table regardless of whether or not the received packet is the head packet, and determining the packet as having been firstly received in absence of a registration of the fragment identification value.

Also, the above-mentioned fragment identification value may be composed of a source address and a fragment ID in an outer header of the head packet.

Also, the above-mentioned first means may include means determining whether or not the received packet is the head packet based on whether or not a fragment offset value in an outer fragment header of the head packet is a predetermined value.

Also, the above-mentioned first means may include means storing the subsequent packet in a buffer to keep it waiting when determining that the subsequent packet is received before the head packet; the packet transfer device may further comprise fourth means, after executing processing of the second means, reading the subsequent packet from the buffer to execute processing of the third means.

Also, the above-mentioned first means may include means determining whether a pattern falls into a pattern I or a pattern II based on whether or not the head packet includes the fragment header indicating that the fragmentation is performed before the encapsulation; the packet transfer device may further comprise fifth means executing processing of the second means when the pattern packet is determined to be the pattern I and executing the second means after generating the fragment header for the head packet when the pattern is determined to be the pattern II, and the third means may include means making a fragment offset value in the fragment header a value obtained by subtracting a header length for the subsequent packet from a value before the decapsulation according to a type of the pattern.

Also, when storing the inner header, the above-mentioned second means also may store a fragment offset value of the head packet in case of the pattern I, may store a fragment offset value generated in case of the pattern II, and the third means may assign the fragment offset value in conformity with the fragmentation to the subsequent packet in either pattern.

Furthermore, the above-mentioned third means may include means changing the fragment offset value of the head packet to a value obtained by subtracting data lengths of the inner header and its fragment header from a fragment offset value in its outer fragment header to be assigned to the subsequent packet when the pattern is the pattern I, and changing the fragment offset value of the head packet to a value obtained by subtracting the data length of the inner header from the fragment offset value in the outer fragment header to be assigned to the subsequent packet when the pattern is the pattern I.

Furthermore, the inner header changed by the above-mentioned third means may be a value obtained by subtracting the data lengths of the outer fragment header and the inner header from a payload length in an outer header in case of the pattern I, and the inner header may be a value obtained by subtracting the data length of the inner header from the payload length in the outer header in case of the pattern II.

The received packet in the packet transfer device may comprise e.g. an IPv6 packet through an IP tunnel.

### BRIEF DESCRIPTION OF THE DRAWINGS

The above and other objects and advantages of the invention will be apparent upon consideration of the following detailed description, taken in conjunction with the accompanying drawings, in which the reference numerals refer to like parts throughout and in which:

FIG. 1 is a block diagram showing one embodiment of a packet transfer device realizing a packet transfer method according to the present invention;

FIG. 2 is a diagram showing a function of each block of the packet transfer device according to the present invention shown in FIG. 1;

FIGS. 3A-3H are sequence diagrams for illustrating an operation concerning a pattern I of a packet transfer method and device according to the present invention;

FIG. 4 is a flowchart showing a processing procedure concerning the pattern I shown in FIGS. 3A-3H;

FIGS. 5A and 5B are frame format diagrams of an IP packet (IPv6/IPv4 packet) generally known;

FIG. 6 is a diagram showing one embodiment of a fragment retrieving table and a header storing table used for the present invention shown in FIG. 1;

FIGS. 7A-7G are sequence diagrams for illustrating an operation concerning a pattern II of a packet transfer method and device according to the present invention;

FIG. 8 is a flowchart showing a processing procedure concerning the pattern II shown in FIGS. 7A-7G;

FIG. 9 is a flowchart showing a processing procedure which can accommodate to both of patterns I and II of the packet transfer method and device according to the present invention;

FIG. 10 is a diagram showing an IPv6 network generally known;

FIGS. 11A-11I are sequence diagrams for illustrating an operation concerning a pattern I in a prior art packet transfer method and device; and

FIGS. 12A-12H are sequence diagrams for illustrating an operation concerning a pattern II in a prior art packet transfer method and device.

### DESCRIPTION OF THE EMBODIMENTS

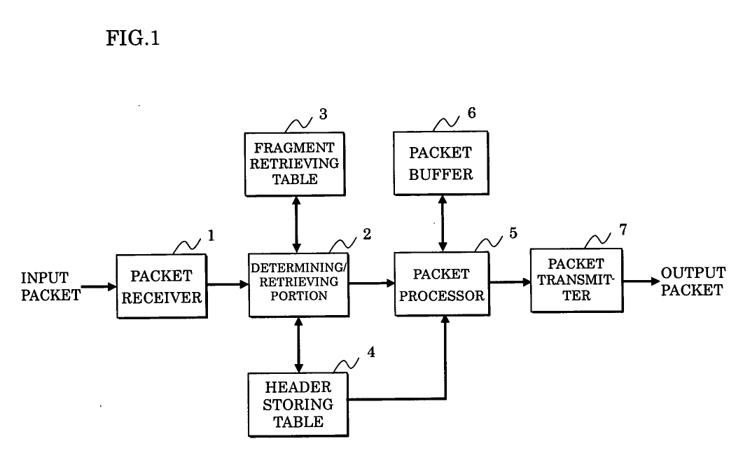

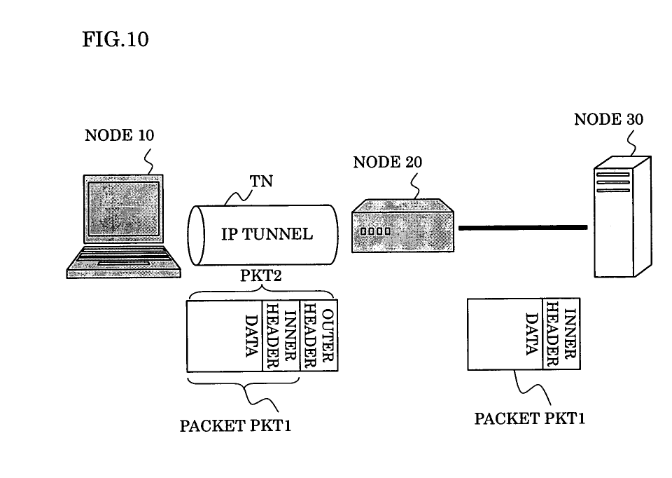

FIG. 1 shows a packet transfer device used for executing a packet transfer method according to the present invention, which specifically corresponds to the node (or router) 20 in the IPv6 network shown in FIG. 10.

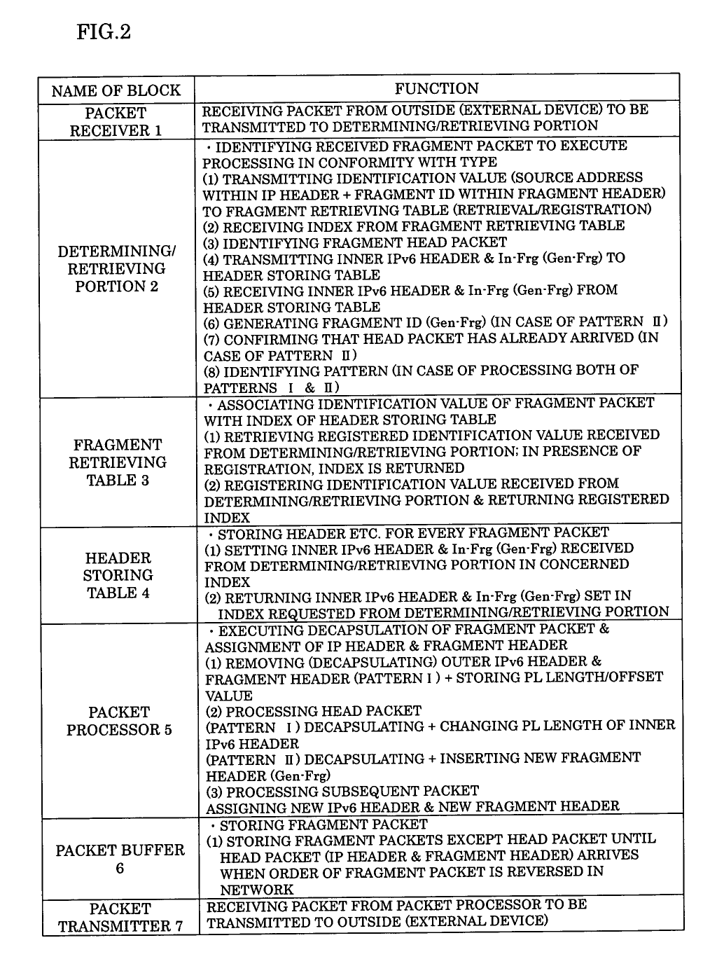

FIG. 2 shows a function of each block of the packet transfer device shown in FIG. 1. A packet receiver 1 receives a packet from outside (external device) such as a node (router) 10 shown in FIG. 10 to be transmitted to a determining/retrieving portion 2.

The determining/retrieving portion 2 identifies a received fragment packet, and is connected to a fragment table 3 and a header storing table 4 for executing processing in conformity with a type of the packet.

The fragment retrieving table 3 is a table associating the identification of the fragment packet with an index of the header storing table 4. The header storing table 4 stores the header or the like for every fragment packet per index.

The determining/retrieving portion 2 is further connected to a packet processor 5. The packet processor 5 performs decapsulation of the fragment packet, and an assignment of an IP header and a fragment header by using the header storing table 4 and a packet buffer 6. The packet buffer 6 stores the fragment packet.

The packet processor 5 is further connected to a packet transmitter 7, which transfers a packet to e.g. the node (router) 30 shown in FIG. 10.

Operation of Pattern I

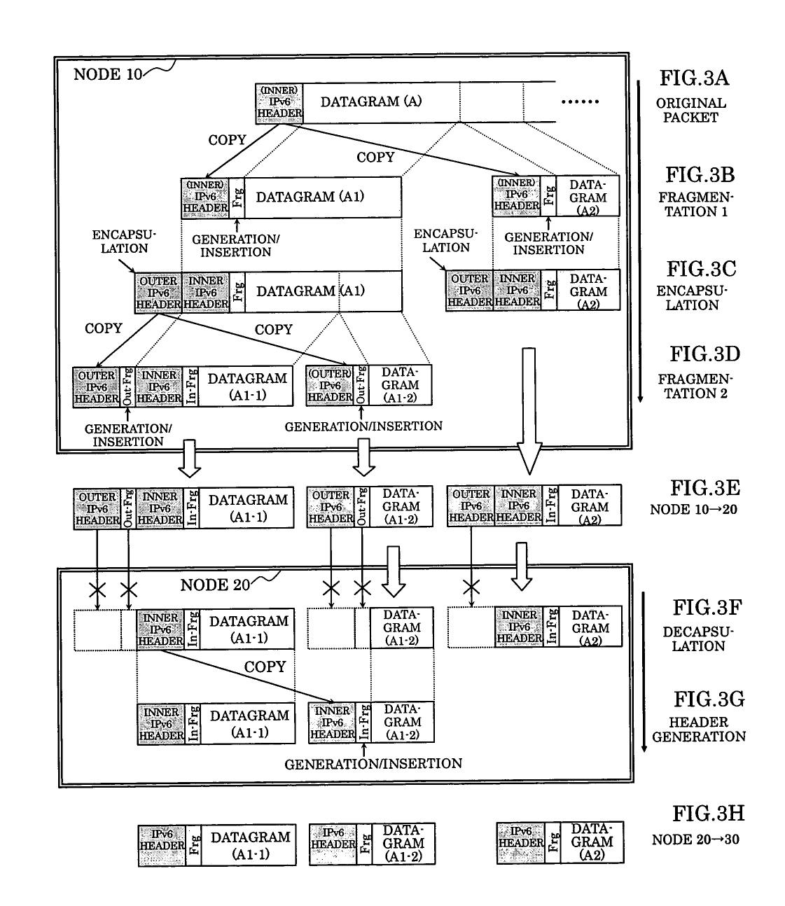

Hereinafter, the operation of pattern I in the packet transfer device shown in FIG. 1 will be described referring to FIGS. 3A-3H, 4, 5A, 5B, and 6.

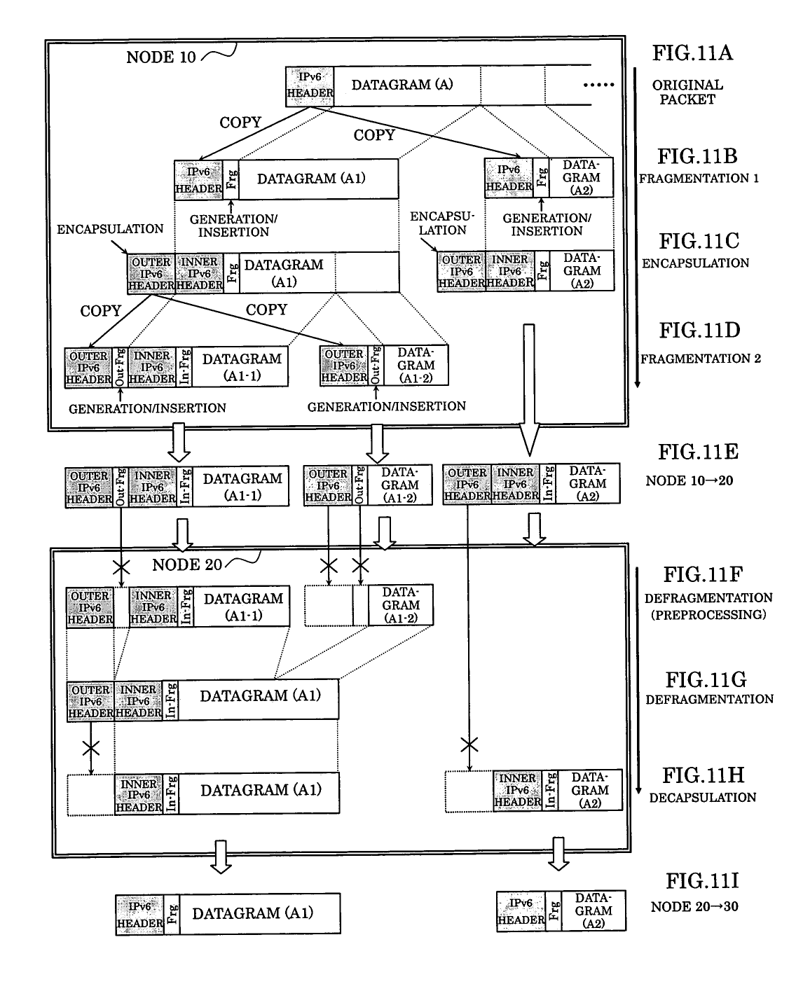

It is to be noted that this operation procedure exemplifies the operation procedure between the nodes 10-30 composing the IPv6 network shown in FIG. 10, and the operation procedure of FIGS. 3A-3D in the node 10 is the same as that in the prior art example shown in FIGS. 11A-11D. Namely, to the original packet shown in FIG. 3A, the fragmentation 1 shown in FIG. 3B is performed, then the encapsulation shown in FIG. 3C is performed, and the fragmentation 2 is performed as shown in FIG. 3D, so that the packet shown in FIG. 3E is transmitted from the node 10 to the node 20.

In the node 20 corresponding to the packet transfer device according to the present invention, firstly the decapsulation is performed as shown in FIG. 3F, outer IPv6 headers are removed and outer fragment headers Out-Frg of the head packet and second packet are removed, and a header is generated as shown in FIG. 3G to be assigned to the second packet. Then, as shown in FIG. 3H, the packet is transferred from the node 20 to the node 30.

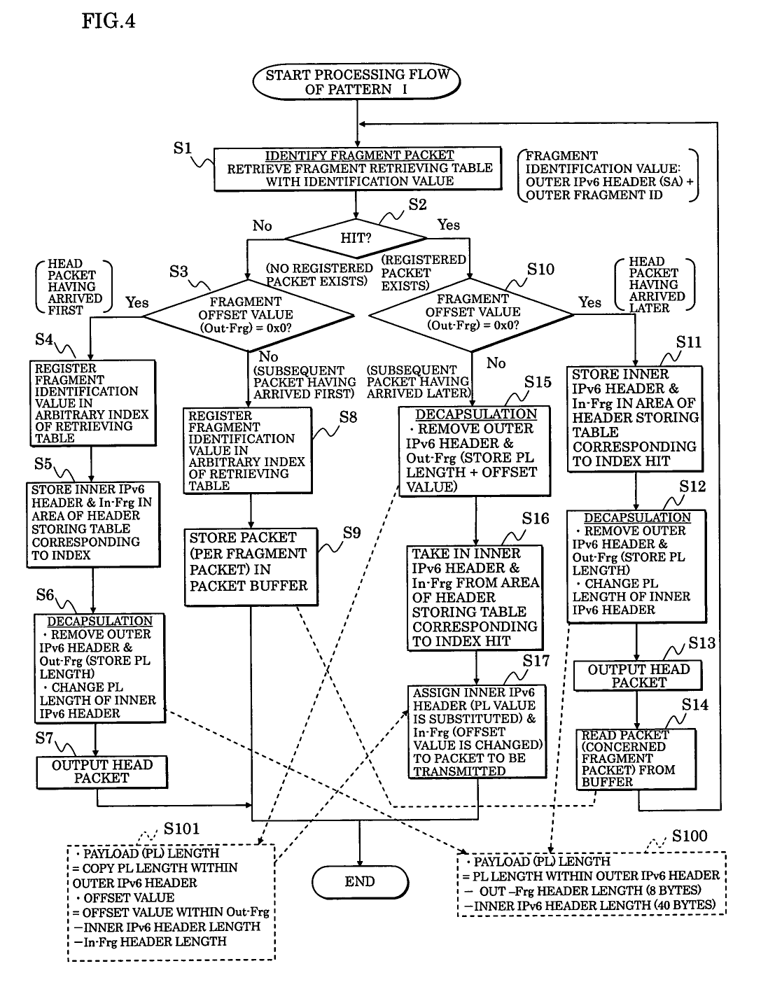

Such decapsulation processing and header generation processing in the node 20 will now be specifically described referring to the flowchart of FIG. 4.

Firstly, it is supposed that the arrival order of packets from the node 10 to the node 20 is not fixed. Therefore, when receiving the fragment packet shown in FIG. 3E from the packet receiver 1, the node 20 starts processing by retrieving the fragment retrieving table 3 to recognize whether or not the received packet is the head packet or the subsequent packet (at step S1: function (1) of the determining/retrieving portion 2 of FIG. 2).

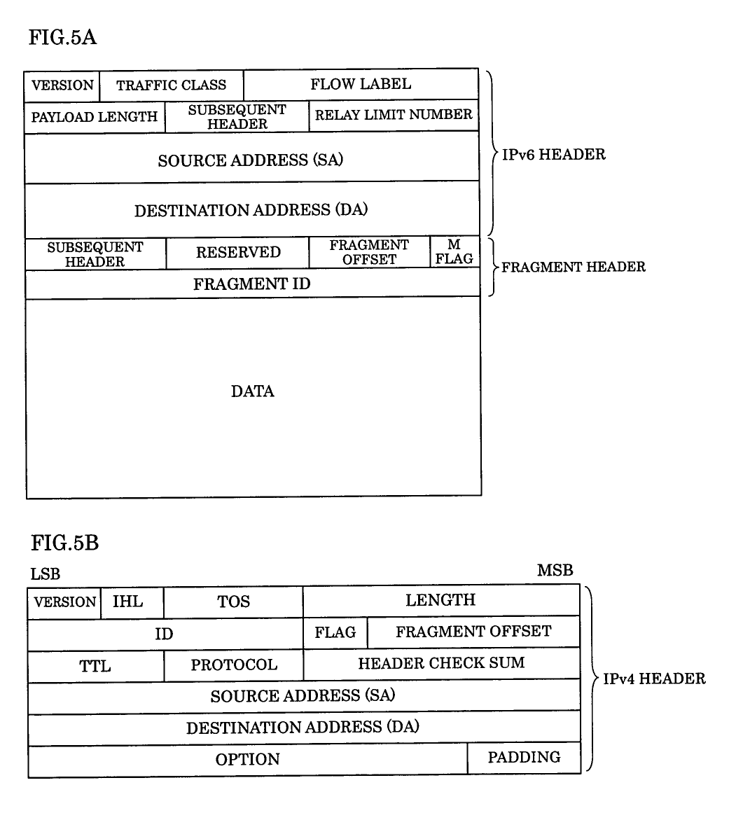

This is for determining the arrival order of the packets received by the determining/retrieving portion 2 based on a fragment identification value composed of a source (transmitting source) IP address (SA) in the outer IPv6 header and a fragment ID composing the fragment header shown in FIG. 5A (functions (1) and (2) of the fragment retrieving table 3).

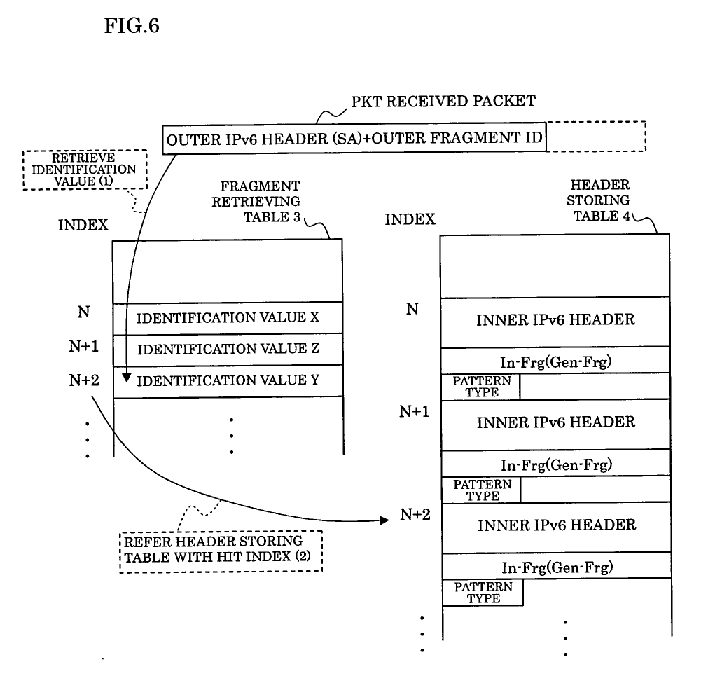

FIG. 6 shows an embodiment of the fragment retrieving table 3, in which identification values X, Z, Y, . . . are stored in indexes N, N+1, N+2, . . . . Whether or not the source address (SA) and the fragment ID of the received packet are preset in any one of the indexes of the fragment retrieving table 3 is retrieved as shown in (1) of FIG. 6 (function (1) of the fragment retrieving table 3).

As a consequence of such a retrieval of the fragment retrieving table 3, in the presence of a hit (when the source address (SA) and the fragment ID are registered in the fragment retrieving table 3) it indicates that a packet having already arrived exists, and in the absence of a hit, it indicates that no packet having arrived first exists (at step S2: function (3) of the determining/retrieving portion 2).

At first, since the fragment packet receives nothing, there is no hit. The process proceeds from step S2 to step S3, where whether or not a fragment offset value (hereinafter, represented by (Out-Frg)) within the outer fragment header Out-Frg is a predetermined value is determined (function (3) of the determining/retrieving portion 2). In this case, the predetermined value is “0”. When the packet is the head packet, the fragment offset value (Out-Frg) is set to “0”. Therefore, the process proceeds from step S3 to step S4. When the fragment offset value (Out-Frg) is not “0”, it indicates that the subsequent packet (second packet in the example of FIG. 3E) is received. Therefore, the process proceeds from step S3 to step S8.

When it is found that the head packet has arrived first, the fragment identification value is registered at step S4 in an arbitrary index of the fragment retrieving table 3 shown in FIG. 6 (function (2) of the determining/retrieving portion 2). Then at step S5, the inner IPv6 header and its fragment offset value (In-Frg) are stored in an area of the header storing table 4 corresponding to the index of the fragment retrieving table 3 (function (4) of the determining/retrieving portion 2 and function (1) of the header storing table 4).

It is to be noted that while the fragment offset value (Gen-Frg) and the pattern type are indicated in the header storing table 4 shown in FIG. 6, this information is not used in the operation of the pattern I but used in the processing of the pattern II described later.

Then, the decapsulation processing is performed at step S6. Firstly, the outer IPv6 header and its outer fragment header are removed (function (1) of the packet processor 5) and then the payload length of the inner IPv6 header is changed (function (2) of the packet processor 5).

It is required to store (copy) the payload length within the outer IPv6 header at the time of removing the headers (function (1) of the packet processor 5). Also, as for the payload length of the inner IPv6 header, it is changed to a value of payload length within IPv6 header-header length (8 bytes) of fragment header Out-Frg-header length (40 bytes) of inner IPv6 header, as shown at step S100.

Thus, the decapsulated packet whose header is generated is outputted to the node 30 from the packet transmitter 7 (at step S7). The head packet in this case is a fragment packet including a datagram (A1-1) shown in FIG. 3H.

When at step S3 the fragment offset value is not “0”, the packet is the subsequent packet having arrived first, as mentioned above. Also in this case, the fragment identification value is registered in an arbitrary index of the fragment retrieving table 3 in the same way as the case of the head packet, namely in the same way as step S4.

Since this subsequent packet can not be outputted, the received subsequent packet is stored in the packet buffer 6 (at step S9: function (1) of the packet buffer 6). This is performed for every fragment packet.

On the other hand, in the presence of a hit at step S2, it is indicated that the identification value has been already registered in the fragment retrieving table 3, and that a packet of some kind has been received. Therefore, whether the received packet is the head packet or the subsequent packet is determined at step S10 (function (3) of the determining/retrieving portion 2).

Namely, it is determined at step S10 whether the packet is the head packet having arrived later or the subsequent packet having arrived later based on whether or not the fragment offset value in the fragment header is “0” in the same way as the above-mentioned step S3.

As a result, when it is found that the fragment offset value is “0”, the packet is the head packet having arrived later. Therefore, step S11 is executed. This step S11 is the same as the above-mentioned step S5, and the inner IPv6 header and its inner fragment header In-Frg are stored in an area of the header storing table 4 corresponding to the index hit (function (4) of the determining/retrieving portion 2).

Then, the decapsulation processing is performed (at step S12). This is the same as the above-mentioned step S6, the outer IPv6 header and the outer fragment header are removed (only the payload length is stored) and the inner IPv6 header length is changed (functions (1) and (2) of the packet processor 5).

Thereafter, the head packet is outputted from the packet transmitter 7 to the node 30 (at step S13).

Since it is indicated that steps S10-S13 are processed for the head packet having arrived later, and that the subsequent packet has already arrived, the packet stored in the packet buffer 6 at above-mentioned step S9 is read from the packet buffer 6 by the packet processor 5 (at step S14). This is performed for every fragment packet concerned.

Thus, the process returns to step S1, at which the identification of the fragment packet is performed to the packet read from the buffer 6 in the same way as the above. As a result, since the packet is naturally hit at step S2, the process proceeds to step S10. Since the packet is the subsequent packet in this case, the fragment offset value is not “0”, so that the process proceeds to step S15.

It is to be noted that as for the case of the subsequent packet having arrived later, the flow of steps S1, S2, S10, and S15 is the same.

At step S15, the decapsulation processing is performed. This is for removing the outer IPv6 header and its outer fragment header in the same way as steps S6 and S12. In this case, the payload length within the outer IPv6 header and the offset value within the outer fragment header are stored (function (1) of the packet processor 5).

At step S16, in the same way as step S11, the inner IPv6 header and its inner fragment header are taken in from the area of the header storing table 3 corresponding to the index hit (function (5) of the determining/retrieving portion 2).

At step S17, the packet to which the inner IPv6 header and the inner fragment header are assigned is outputted from the packet transmitter 7.

In this case, as for the inner IPv6 header, as shown in the above-mentioned step S101, the payload length for the inner IPv6 header is replaced by the payload length within the outer IPv6 header copied at step S15. As for the offset value in the inner fragment header, a value obtained by subtracting the header lengths of the inner IPv6 header and the inner fragment header from the offset value within the outer fragment header is assigned (function (3) of the packet processor 5).

Thus, the encapsulation is performed after the fragmentation. However, in the pattern I in which the fragmentation has occurred again, the received fragment packet in which a datagram portion is unchanged and only the header portion is changed is transferred, thereby enabling the defragmentation at the subsequent node 30.

Operation of Pattern II

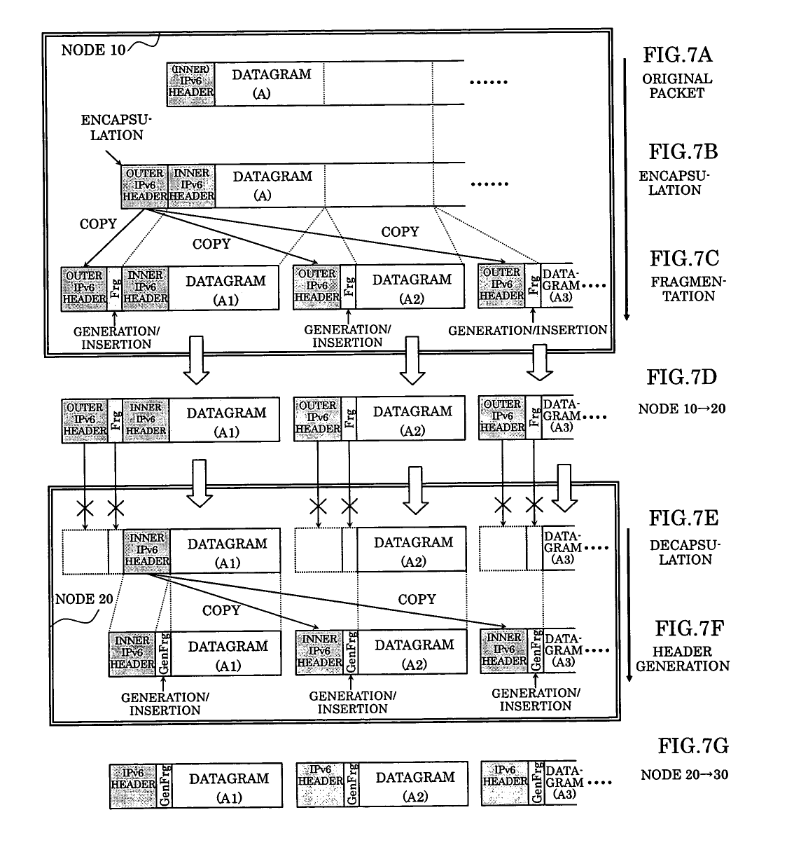

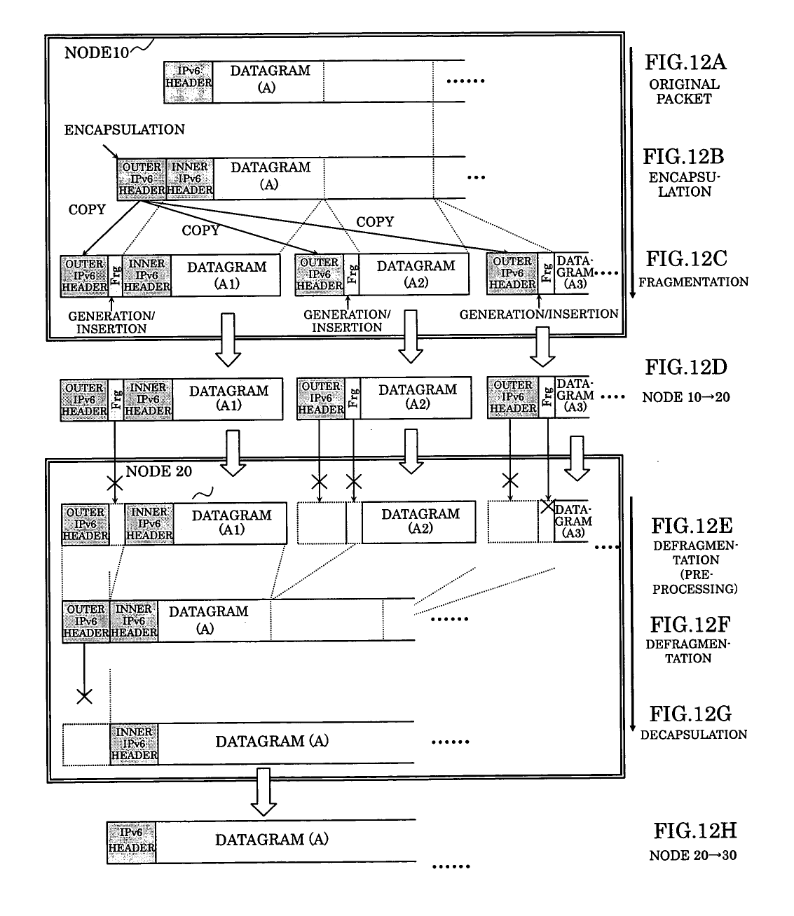

FIGS. 7A-7G show an operation sequence in the pattern II of the packet transfer method and device according to the present invention. In this pattern II, in the same way as the prior art example shown in FIGS. 12A-12H, the fragmentation is performed after the encapsulation. The original packet shown in FIG. 7A is encapsulated as shown in FIG. 7B, and is further fragmented as shown in FIG. 7C. Then, the packet is transmitted from the node 10 to the node 20 as the fragment packet as shown in FIG. 7D.

In the node 20 which realizes the packet transfer method and device according to the present invention, the decapsulation is firstly performed as shown in FIG. 7E. The outer IPv6 header is removed and its fragment header Frg is also removed. As shown in FIG. 7F, the inner IPv6 header of the head packet is copied to be assigned to the subsequent packet and a new fragment header Gen-Frg is generated to be inserted between the inner IPv6 header and each of the datagrams, so as to make a fragment packet as shown in FIG. 7G, which is transmitted to the node device 30.

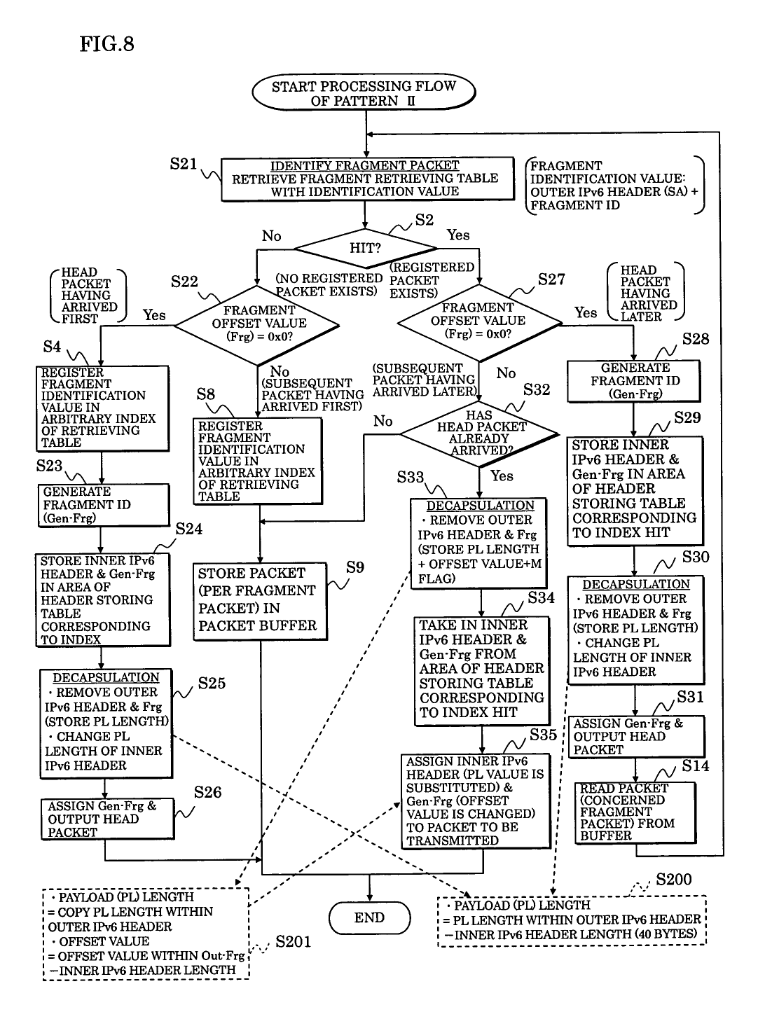

Such an operation procedure in the pattern II of the node 20 will now be described referring to the flowchart shown in FIG. 8. It is to be noted that the same reference numerals as those of the flowchart shown in FIG. 4 indicate the same parts or corresponding parts. Accordingly, in the following description, only steps different from those in FIG. 4 will be described.

Firstly, step S21 is different from step S1 shown in FIG. 4 in that the fragment ID is not the outer fragment ID but a simple fragment ID. This is because, as it can be found by comparing FIGS. 3A-3H with FIGS. 7A-7G, the fragment header is not required to be generated in the encapsulation shown in FIG. 7B, and it is firstly generated to be inserted for the outer IPv6 header in the fragmentation shown in FIG. 7C. Since the inner fragment header is not required, the fragment header is not called the outer fragment header but merely called a fragment header Frg.

This can be applied to steps S22 and S27 which determine whether or not the fragment offset value (Frg) is “0”.

At step S23, the fragment ID, i.e. the fragment header Gen-Frg including the fragment ID is generated for the head packet having arrived first (function (6) of the determining/retrieving portion 2). This is for firstly generating the fragment ID, since the outer IPv6 header and its fragment header Frg are removed by the decapsulation as shown in FIG. 7E in the header generation processing shown in FIG. 7F and the fragment header for each fragment packet is eliminated. The fragment ID in this case has the same value in the fragment header in any fragment packet.

Step S24 is different from step S5 in FIG. 4 in that not the inner fragment header In-Frg but the fragment header Gen-Frg generated at step S23 is stored (function (4) of the determining/retrieving portion 2). Also, step S25 is different from FIG. 4 in that not the outer fragment header Out-Frg but the fragment header Frg is removed.

It is to be noted that while the payload length of the inner IPv6 header is changed at step S25, the payload length in this case is one obtained by subtracting the header length (40 bytes) of the inner IPv6 header from the payload length within the outer IPv6 header shown at step S200, and the subtraction of the outer fragment header (8 bytes) is as shown at step S100 of FIG. 4 not required since it corresponds to the fragment header Gen-Frg generated at step S23 (function (2) of the packet processor 5).

At step S26, the packet to which the fragment header Gen-Frg generated at step S23 is assigned is transmitted from the packet transmitter 7 of the node 20 to the node 30.

On the other hand, at step S27, whether or not the packet is the head packet having arrived later is determined in the same way as step S10 of FIG. 4. When it is found that the packet is the head packet having arrived later, the process proceeds to step S28. Also in this case, in the same way as step S23, the fragment ID is generated to be inserted into the fragment header Gen-Frg (function (2) of the packet processor 5).

Step S29 corresponds to step S24, and step S30 corresponds to step S25. Furthermore, step S31 corresponds to step S26. Thus, after the head packet having arrived later is transmitted to the node 30, the packet having been already stored in the packet buffer 6 is read, and the process returns to step S21 in the same way as the case of FIG. 4 to execute the same processing.

When it is determined that the packet is not the head packet having arrived later at step S27, namely it is found that the packet is a subsequent packet having arrived later, whether or not the head packet has already arrived is determined (at step S32: function (7) of the determining/retrieving portion 2).

While in case of the pattern I shown in FIGS. 3A-3H, only two fragment packets are basically generated in the fragmentation 2 shown in FIG. 3D, in case of the pattern II shown in FIGS. 7A-7G, two or more fragment packets as shown in FIG. 3C may be generated. Even if the packet is a subsequent packet having arrived later, whether or not the packet having arrived before that packet is the head packet is not known. Therefore, the determination is performed at step S32.

Accordingly, when it is found that the head packet has not arrived (for this recognition, the existence of the fragment ID generated at step S23 or the like may be confirmed), the process proceeds to step S9 and the packet is stored in the packet buffer 6. When it is found that the head packet has already arrived, the process proceeds to step S33.

At step S33, the decapsulation is performed. In this case, at the time of removing the outer IPv6 header and its fragment header Frg, the payload length within the outer IPv6 header is stored (copied), and the offset value and M flag within the fragment header Frg are also stored. This M flag indicates the end of the fragment packet. In case of the pattern I, it is not required since other fragment packets continue.

At step S34, in the same way as step S16 of FIG. 4, the inner IPv6 header and the fragment header Gen-Frg generated at step S23 or S28 are taken in from the area of the header storing table 4 corresponding to the index hit (function (2) of the header storing table 4).

At step S35, in the same way as step S17 of FIG. 4, the inner IPv6 header and the fragment header Gen-Frg are assigned (function (3) of the packet processor 5) to the packet to be transmitted to the node 30. The payload length for the inner IPv6 header in this case may be replaced by the payload length within the outer IPv6 header stored at step S33. Also, the fragment offset value within the fragment header Gen-Frg is a value obtained by subtracting the header length of the inner IPv6 header from the offset value within the fragment header stored at step S33 as shown at step S201.

Thus, the packet transfer is realized by the decapsulation and the header generation also in the processing of the pattern II, and the defragmentation of the packet is excluded, so that the defragmentation in the subsequent node is enabled.

Operation of patterns I + II

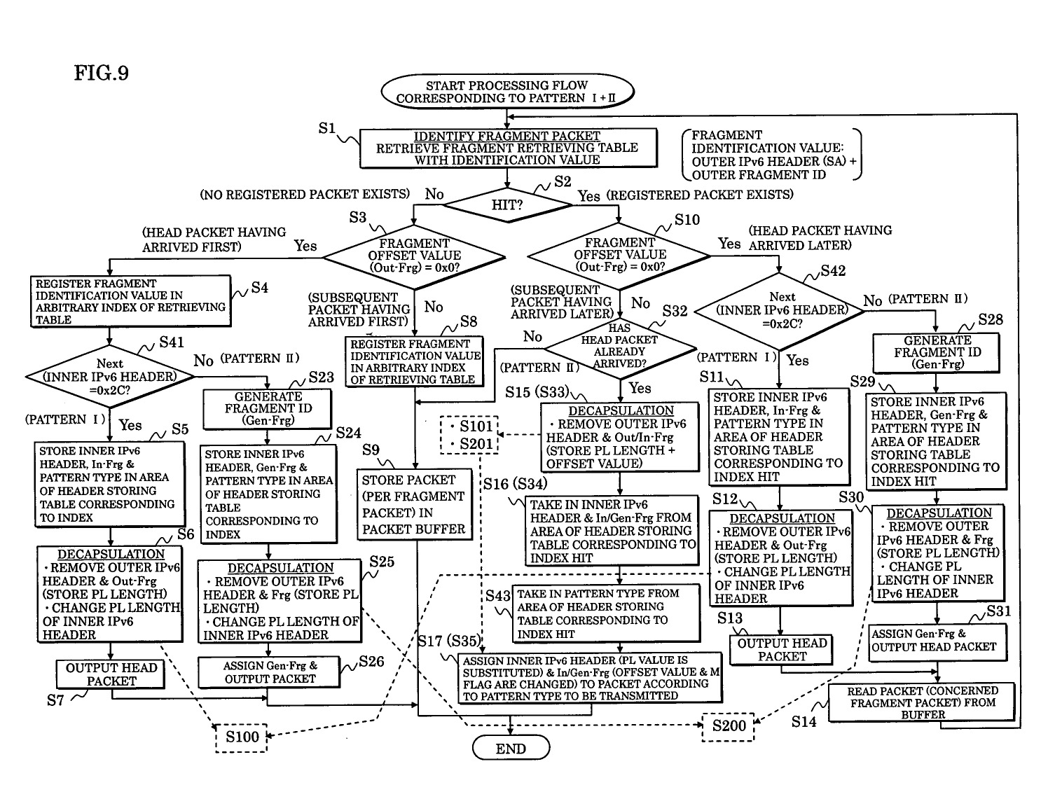

FIG. 9 shows a processing procedure in a case where the above-mentioned processings of the patterns I and II are enabled at the same time. Hereinafter, the same reference numerals indicate the same parts in FIGS. 4 and 8, where parts indicated by reference numerals different from those in FIGS. 4 and 8 will be described.

Firstly, it is determined at step S41 whether the pattern is the pattern I or the pattern II (function (8) of the determining/retrieving portion 2). While in case of the pattern I, the inner fragment header In-Frg exists after the inner IPv6 header, in case of the pattern II, the inner fragment header In-Frg does not exist, which will be recognized by comparing the fragment packet of FIG. 3E with the fragment packet of FIG. 7D. From this difference, it becomes possible to determine whether or not a Next field in the inner fragment header In-Frg is “2 C” (base 16 number), and to determine that the pattern is the pattern I in case of Next=“2 C” and that the pattern is the pattern II if not the case.

Thus, after determining whether the pattern is pattern I or II at step S41, steps S5-S7 are executed in case of the pattern I, and steps S23-S26 are executed in case of the pattern II.

However, at steps S5 and S24, the pattern type indicating the pattern I or II determined at step S41 is stored in the header storing table 4 as shown in FIG. 6.

The determination of the pattern I or II at step S41 can be similarly performed at step S42. When it is found that the pattern is the pattern I, steps S11-S13 are executed. When it is found that the pattern is the pattern II, steps S28-S31 are executed. In either pattern, the process proceeds to step S14 to read the packet from the buffer 6.

Also in this case, the pattern type is stored at steps S11 and S29.

On the other hand, as for the processing of the subsequent packet having arrived later in a case where the head packet has already arrived at step S32, almost common processing is performed in the pattern I and pattern II (function (3) of the packet processor 5). Namely, in case of the pattern I, steps S15-S17 are executed, and step S43 is executed between steps S16 and S17. This is because the processing of taking in the pattern type from the area of the header storing table 4 corresponding to the index hit is required.

Namely, since the decapsulation is performed at step S15, the outer IPv6 header and the outer fragment header Out-Frg are removed, and the payload length within the outer IPv6 header is copied at the same time. Also, since the pattern type is not recognized, the offset value is only stored.

At step S16, the inner IPv6 header and the inner fragment header In-Frg are taken in from the area of the header storing table 4 corresponding to the index hit.

After executing step S43, according to a pattern type, in case of the pattern I, the packet to which the inner IPv6 header and the inner fragment header In-Frg with the updated fragment offset value are assigned is transmitted at step S17. As for the offset value updated in this case, the value is obtained by subtracting the header lengths of the inner IPv6 header and the inner fragment header In-Frg from the offset value within the outer fragment header Out-Frg.

Also, in case of the pattern II, the payload length within the outer IPv6 header is copied at step S33. Since the pattern type is not recognized, the offset value is only stored.

At step S34, processing similar to step S16 is performed. After the pattern type is taken in at step S43, the payload of the outer IPv6 header copied at step S33 is replaced by the payload length of the inner IPv6 header according to the type, i.e. the pattern II at step S35 to be used. Also, the updated value obtained by subtracting the header length of the inner IPv6 header from the offset value within the fragment header Frg is used for the offset value of the fragment header Gen-Frg. As for the M flag, a value obtained by copying an M flag value within the fragment header Frg is used. This value is assigned to the packet to be transmitted to the node 30.

Thus, whatever pattern the received packet may have, the pattern is automatically determined and processing corresponding to the pattern is performed, thereby enabling processing which excludes the defragmentation in any case to be realized.

While the example applying the IPv6 frame shown in FIG. 5A to the present invention has been described in the above-mentioned embodiments, it is possible to similarly apply the IPv4 frame shown in FIG. 5B to the present invention.

Namely, when the present invention is applied in the IPv4 network, not the fragment header but the ID (identifier), the flag, the fragment offset within the IPv4 header are used. In that case, the following translation is performed.

| | [In case of IPv6] | [In case of IPv4] |
|---|---|---|
| ID (Identifier) | Source Address (SA) within | Source Address within |
| | IPv6 header + fragment ID | IPv4 header + ID |
| | within fragment header | (Identifier) within IPv4 |
| | | header |
| Offset | Offset within fragment | Offset within IPv4 header |
| | header | |
| Fragment | M flag within fragment | MF flag within IPv4 |
| continuation | header | header |

Also, the determination of the pattern I or It is performed by an MF flag within the inner IPv4 header of the head packet as follows:

In case of 1 (fragment continues), the pattern is “pattern I ”;

In case of 0 (no fragment continues), the pattern is “pattern II”.

As described above, a packet transfer method and device according to the present invention are arranged so that a head packet and a subsequent packet are detected from received packets to which fragmentation is performed after encapsulation; an inner header of the head packet detected is stored and then the head packet is decapsulated and the inner header is changed in conformity with the decapsulation; and the subsequent packet is decapsulated and the inner header of the head packet and a fragment header changed corresponding to the fragmentation are assigned to each packet to be outputted.

In a network device having a gigabit class of interface, throughput at a wire speed has been indispensable for purposes such as a relay of streaming data. In the conventional technology, the defragmentation has been processed with software at the expense of a transfer rate or with hardware having an extremely large-scale memory. However, with the packet transfer method and device according to the present invention adopted, it becomes possible to perform defragmentation equivalent processing of the wire speed with a small-scale hardware, and to reduce a delay of packet assembling which has been required to a level of a regular packet delay.

1. A packet transfer method comprising:
a first step of detecting a head packet and a subsequent packet from received packets to which fragmentation is performed after encapsulation;
a second step of storing an inner header of the head packet detected by the first step and then decapsulating the head packet and changing the inner header in conformity with the decapsulation; and
a third step of decapsulating the subsequent packet and of having the inner header of the head packet changed by the second step and a fragment header generated corresponding to the fragmentation assigned to each packet to be outputted.

2. The packet transfer method as claimed in claim 1, wherein the first step includes a step of preliminarily registering a fragment identification value in a table regardless of whether or not the received packet is the head packet, and of determining the packet as having been firstly received in absence of a registration of the fragment identification value.

3. The packet transfer method as claimed in claim 2, wherein the fragment identification value is composed of a source address and a fragment ID in an outer header of the head packet.

4. The packet transfer method as claimed in claim 2, wherein the first step includes a step of determining whether or not the received packet is the head packet based on whether or not a fragment offset value in an outer fragment header of the head packet is a predetermined value.

5. The packet transfer method as claimed in claim 1, wherein the first step includes a step of storing the subsequent packet in a buffer to keep it waiting when determining that the subsequent packet is received before the head packet; the packet transfer method further comprising a fourth step after the second step of reading the subsequent packet from the buffer to execute the third step.

6. The packet transfer method as claimed in claim 1, wherein the first step includes a step of determining whether a pattern falls into a pattern I or a pattern II based on whether or not the head packet includes the fragment header indicating that the fragmentation is performed before the encapsulation; the packet transfer method further comprising a fifth step of executing the second step when the pattern is determined to be the pattern I and of executing the second step after generating the fragment header for the head packet when the pattern is determined to be the pattern II, and the third step includes a step of making a fragment offset value in the fragment header a value obtained by subtracting a header length for the subsequent packet from a value before the decapsulation according to a type of the pattern.

7. The packet transfer method as claimed in claim 6, wherein when storing the inner header, the second step also stores a fragment offset value of the head packet in case of the pattern I, stores a fragment offset value generated in case of the pattern II, and the third step assigns the fragment offset value in conformity with the fragmentation to the subsequent packet in either pattern.

8. The packet transfer method as claimed in claim 6, wherein the third step includes a step of changing the fragment offset value of the head packet to a value obtained by subtracting data lengths of the inner header and its fragment header from a fragment offset value in its outer fragment header to be assigned to the subsequent packet when the pattern is the pattern I, and of changing the fragment offset value of the head packet to a value obtained by subtracting the data length of the inner header from the fragment offset value in the outer fragment header to be assigned to the subsequent packet when the pattern is the pattern II.

9. The packet transfer method as claimed in claim 8, wherein the inner header changed by the third step is a value obtained by subtracting the data lengths of the outer fragment header and the inner header from a payload length in an outer header in case of the pattern I, and the inner header is a value obtained by subtracting the data length of the inner header from the payload length in the outer header in case of the pattern II.

10. The packet transfer method as claimed in claim 1, wherein the received packet comprises an IPv6 packet or an IPv4 packet through an IP tunnel.

11. A packet transfer device comprising:
first means detecting a head packet and a subsequent packet from received packets to which fragmentation is performed after encapsulation;
second means storing an inner header of the head packet detected by the first means and then decapsulating the head packet and changing the inner header in conformity with the decapsulation; and
third means decapsulating the subsequent packet and having the inner header of the head packet changed by the second means and a fragment header corresponding to the fragmentation assigned to each packet to be outputted.

12. The packet transfer device as claimed in claim 11, wherein the first means include means preliminarily registering a fragment identification value in a table regardless of whether or not the received packet is the head packet, and determining the packet as having been firstly received in absence of a registration of the fragment identification value.

13. The packet transfer device as claimed in claim 12, wherein the fragment identification value is composed of a source address and a fragment ID in an outer header of the head packet.

14. The packet transfer device as claimed in claim 12, wherein the first means include means determining whether or not the received packet is the head packet based on whether or not a fragment offset value in an outer fragment header of the head packet is a predetermined value.

15. The packet transfer device as claimed in claim 11, wherein the first means include means storing the subsequent packet in a buffer to keep it waiting when determining that the subsequent packet is received before the head packet; the packet transfer device further comprising fourth means, after executing processing of the second means, reading the subsequent packet from the buffer to execute processing of the third means.

16. The packet transfer device as claimed in claim 11, wherein the first means include means determining whether a pattern falls into a pattern I or a pattern II based on whether or not the head packet includes the fragment header indicating that the fragmentation is performed before the encapsulation; the packet transfer device further comprising fifth means executing processing of the second means when the pattern packet is determined to be the pattern I and executing the second means after generating the fragment header for the head packet when the pattern is determined to be the pattern II, and the third means include means making a fragment offset value in the fragment header a value obtained by subtracting a header length for the subsequent packet from a value before the decapsulation according to a type of the pattern.

17. The packet transfer device as claimed in claim 16, wherein when storing the inner header, the second means also store a fragment offset value of the head packet in case of the pattern I, store a fragment offset value generated in case of the pattern II, and the third means assign the fragment offset value in conformity with the fragmentation to the subsequent packet in either pattern.

18. The packet transfer device as claimed in claim 16, wherein the third means include means changing the fragment offset value of the head packet to a value obtained by subtracting data lengths of the inner header and its fragment header from a fragment offset value in its outer fragment header to be assigned to the subsequent packet when the pattern is the pattern I, and changing the fragment offset value of the head packet to a value obtained by subtracting the data length of the inner header from the fragment offset value in the outer fragment header to be assigned to the subsequent packet when the pattern is the pattern II.

19. The packet transfer device as claimed in claim 18, wherein the inner header changed by the third means is a value obtained by subtracting the data lengths of the outer fragment header and the inner header from a payload length in an outer header in case of the pattern I, and the inner header is a value obtained by subtracting the data length of the inner header from the payload length in the outer header in case of the pattern II.

20. The packet transfer device as claimed in claim 11, wherein the received packet comprises an IPv6 packet or an IPv4 packet through an IP tunnel.
